(19) United States
(12) Patent Application Publication
(10) Pub. No.: US 2015/0012817 A1
(43) Pub. Date: Jan. 8, 2015

(54) Browser-Based Designer Tool For A User Interface And The Administration Of Tiles

(71) Applicants: Karl Redenbach, New York,, NY (US); Sepideh Ghajar, New York, NY (US); Damien K. Robinson, New York, NY (US)

(72) Inventors: Karl Redenbach, New York,, NY (US); Sepideh Ghajar, New York, NY (US); Damien K. Robinson, New York, NY (US)

(21) Appl. No.: 14/322,444

(22) Filed: Jul. 2, 2014

Related U.S. Application Data
(60) Provisional application No. 61/842,719, filed on Jul. 3, 2013.

(51) Int. Cl. G06F 17/22

(52) U.S. Cl. CPC G06F 17/2247
USPC 715/235

(57) ABSTRACT

Systems and methods for users to create and modify a tile based intranet, internet or extranet website, including functional tiles. The content and the placement of the tiles or a group of tiles can be easily changed without the user needing to know computing coding or web-development languages such as a prototype-based scripting language or markup languages. The systems and methods can be used to a tile based intranet, internet or extranet website for any computing device and allows the user to save templates for such computing devices such as mobile telephones for others to access and acquire.

This application claims priority of U.S. Provisional Application No. 61/842,719 filed on Jul. 3, 2013.

### BACKGROUND

Currently there are no web-based user interface tools that are enabled by a web browser that allows a user or administrator to design or modify a tile based user interface. Further, there is no tool that allows an end user or non-technical user to easily drag and drop tiles and functional tiles into a browser based design tool to easily create an intranet, internet or extranet website.

Prior to the current invention, the creation of an intranet, internet or extranet website with tiles was typically conducted by a developer or web designer using client based tools which require specific technical know-how and training. Moreover, these client based tools are time-consuming and complicated to use. In addition, the client based tools that are currently used to modify and change tiles for web based applications are varied and require technical know-how.

Additionally, unless the user has acquired special training, if a user wishes to change or modify a tile for his intranet, internet or extranet, the user has to employ a developer to make these modifications using complex development tools which can be costly.

Prior art methods and systems exist for arranging tiles on the user interface of mobile computing devices such as the systems and methods set forth in U.S. Pat. No. 7,933,632 and U.S. Pub. No. 2013/0057588 the teaching and disclosure of which are incorporated by reference as if fully set forth below. However, there is no systems and methods in the prior art that are enabled by a web browser to allow a user to design or modify a tile based user interface without requiring extensive technical skill and coding expertise.

Thus, there has been a long felt but unmet need for a system and method to allow non-technical users to design and modify a tile based user interface to create an intranet, internet or extranet website.

### SUMMARY

The inventors have developed a system and method for users to create and modify a tile based intranet, internet or extranet website, including a website containing functional tiles. It should be noted that throughout this specification the word “including” means “including but not limited to.” The content and the placement of the tiles can be easily changed without the user needing to know computing coding or web-development languages such as a prototype-based scripting language or markup languages.

The system and methods presented herein can be used to create tile based intranet, internet or extranet websites on any type of Web application platform associated with intranet content management and document management.

The system and methods is especially useful as an interface design tool for Microsoft SharePoint® products. The system and methods described herein can be employed with both premise and online SharePoint® versions, including SharePoint® 2010 and SharePoint® 2013.

The system and methods described herein also work with non SharePoint® solutions, including .Net, PHP, Java, C++, C#, Ruby, Python and Lua.

The system and methods allows the user to create a multitude of different tile arrangements and configurations. Additionally, the system and methods can provide out of the box templates greatly reducing the time to build a tile based intranet, internet or extranet websites. The ability to create customizable tile configurations or to use pre-set templates allows for the best user experience available, which will lead to an intranet, extranet, or internet site having the highest adoption rate.

This summary is provided to introduce simplified concepts for using a browser based tool for the user interface and administration of tiles that are further described below in the Detailed Description and/or shown in the Figures. This summary is not intended to identify essential features of the claimed subject matter, nor is it intended for use in determining the scope of the claimed subject matter. The term “techniques” as used herein can include devices, systems, apparatuses, components, operations, and/or methods as permitted by the context in which the term is used.

### BRIEF DESCRIPTIONS OF THE DRAWINGS

Embodiments for arranging tiles are described with reference to the following drawings. The same numbers are used throughout the drawings to reference like features and components:

FIG. 1 illustrates the high level architecture.

FIG. 2 illustrates create page and choose template.

FIG. 3 illustrates the tiles Workspace.

FIG. 4 illustrates the tiles Workspace and also shows the user's options in edit mode.

FIG. 4A illustrates a tile containing a delete function in a softkey bar.

FIG. 5 illustrates tile pages—open, save, and save to gallery.

FIG. 6 illustrates the standard tiles.

FIG. 7 illustrates the different tiles known as functional tiles.

FIG. 8 illustrates the concept of group tiles.

FIG. 9 illustrates tile configuration and saving to the gallery.

FIG. 10 illustrates the MobileBuild feature.

FIG. 11 illustrates touchlists.

FIG. 12 illustrates a methodology for creating a new page using a page template from the page gallery.

FIG. 13 illustrates a methodology for editing and adding tiles utilizing the Tile Menu in the Workspace.

FIG. 14 illustrates a methodology for creating a set of grouped tiles and saving this as a group in a group gallery.

FIG. 15 illustrates a methodology for creating a mobile site via the Workspace using the MobileBuild function.

### DETAILED DESCRIPTION

Overview

This document describes techniques for using a browser based tool for the user interface and administration of tiles. These techniques enable users to easily change, modify or replace tiles and tile functions to create a customized intranet, internet or extranet website. Further, techniques are taught to enable users to easily change, modify or replace and modify tiles and tile functions using a web browser to create a customized intranet, internet or extranet website.

The following is an example of how using a browser based tool for the user interface and administration of tiles can be used across systems and methods.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Example System

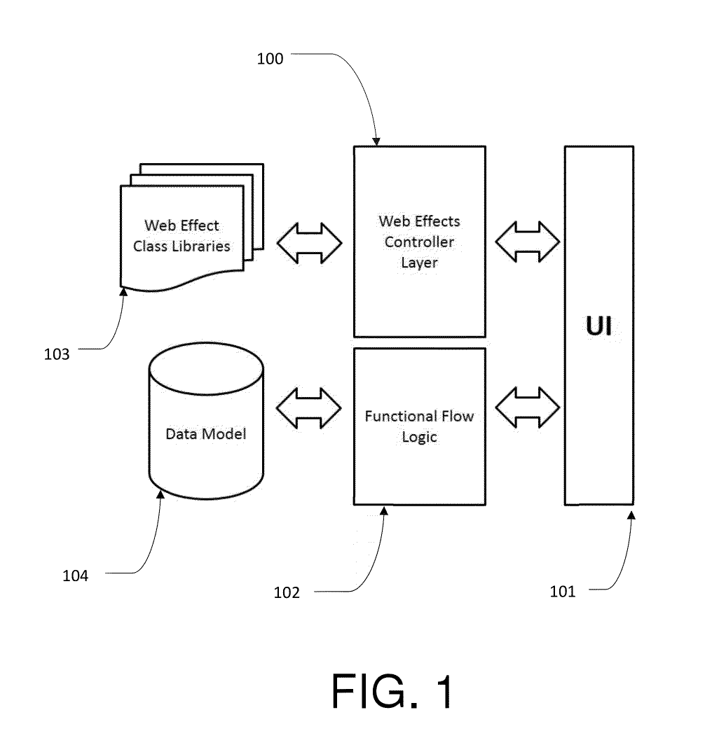

FIG. 1 illustrates an example system in which techniques for arranging tiles can be implemented. This example illustrates the use of the technique for SharePoint® Pages but it is understood that the system and technique can be used with any type of Web application platform. A person of skill in the art would recognize the proceeding description in its relation to the features and functionalities of SharePoint®. The User Interface 101 consists of SharePoint® Pages. The Web Effects Controller Layer Component 100 is comprised of connector classes to fetch JavaScript (JS) Functions and switch on the Cascading Style Sheets (CSS). The implementing options are as follows: C# Class and JS Class. The Web Effect Class Libraries 103 are JS and CSS class libraries for web effects, and the implementing options are Web Service, Class Library or Farm Solution Pack. These web effects include functional tiles and logic that are contained within the tile so that when a Web Service, Class Library or Farm Solution Pack is implemented, the specific functionality of the tile is called. The Web Service, Class Library and Farm Solution Packs are ways of implementing the connectivity of functional tiles. The Functional Flow Logic Component 102 consists of a class library to interact with data model component and implement functional flow such as: Administrative Scenarios, Portal Memory, Site Navigation, etc. The Data Model Component 104 is comprised of SharePoint® Lists of: Solution Template Gallery, Custom Template Gallery, and Portal Memory. A person of skill in the art would understand the nature and function of the above terms and description in relation to SharePoint®.

The system can also include additional components that are not shown in FIG. 1. For example, the system can contain an interface component, an input component and a tile management component. The system can receive input from one or more interface components to select, modify or perform other tasks.

Input from the interface component can include content obtained from one or more software applications. Input can also include user input generated using a touch screen, touch sensitive display, keypad, joystick, touchscreen gesture or any other type of control. The interface component can be single interface component or multiple interface components, including separate interface components for user input and input from applications.

The input component obtains, receives and/or requests input including user input and content from the interface component. The input can be used to select a function or tile and generate the view of the tile space. A tile manager component manages a set of tiles that can be displayed in a tile space.

The example set forth above was an exemplary embodiment of the invention and is not meant to limit the scope of the invention.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Additionally, it should be noted that one or more components may be combined into a single component providing aggregate functionality or divided into several sub-components. The components may also interact with one or more other components not specifically described herein but known by those of skill in the art.

Example Methods

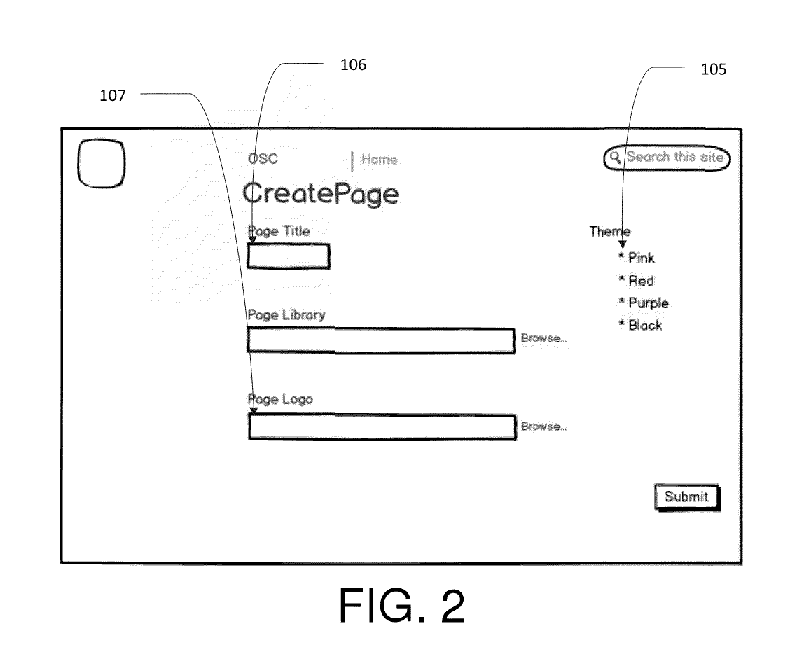

FIG. 2 illustrates a user in administrative view or the web tile creation page for creating a new page. This administrative page can be implemented within SharePoint® and also outside of SharePoint® in any web based browser application or product. Preferably, the technique will have different views or modes depending on the situation or function required. However, all features, functions or techniques can be set forth in one view or mode or selected from drop down menus or by selecting icons on the workspace or in the task or softkey bars. For example, the technique may contain a normal page mode view that will show how the tile based intranet; internet or extranet webpage will look when viewed on an intranet, internet or extranet websites. The technique may also contain an administrative view that will allow a user to create and modify tile based intranet, internet or extranet webpage. Access to the administrative view may be limited to certain users to prevent unrequested modifications of tile based intranet, internet or extranet webpage. In addition, techniques for editing the tiles and workspace and configuring tiles or groups of tiles can be included in separate views or modes or accessed in one of the existing modes or views.

Preferably, each view will contain a component, icon, tab or way to allow the user to navigate between views. When a user wants to create or modify a tile based page for an intranet, internet or extranet website the user accesses a view such as administrative view that gives privilege or the right to create and modify tile based intranet, internet or extranet pages. The user either through prompts or through user action can select a previously created template of an array of tiles or choose to create a new page. Previously created templates can be saved at any database, list or folder that allows access by the user such as a gallery list. The method can allow the user to configure the tile based page or template either through prompts or user action such as clicking on a link to cause a pop up box or lists to appear containing possible configuration options. Alternatively, the method can be set up for the user to configure the page in other ways, including through the use of softkeys or icons on a portion of the page or screen. Each configuration option can include a list or possible choices displayed in numerous ways, including in a drop down list, radio buttons or icons. The method can provide defaults choices for each option that would be implemented if the user does not select a different choice. When the user is finished with the page configuration options the method can provide a technique for the user to accept the configuration parameters whereupon these options are implemented on the page.

The illustrative example of FIG. 2 shows that a configuration function has been invoked. In this example, the user is prompted to pick a color theme 105, give the page a title 106, and select a page logo 107. These are only some of the features that can be selected. Additional features can include background, application link, list of application types, and preview in application gallery. In the illustrative example of FIG. 2 a Submit button or icon is provided for the user to accept the configuration options selected. Clicking on this will implement the configuration options and take the user out of the configuration function.

Preferably after the user has configured the selected template or new page the method will proceed to the tile Workspace page where the user can add, delete and modify tiles to the tile based intranet, internet or extranet websites. However, the order of the steps is not important and any of the steps listed above and below can be performed in any order. For example, configuration of the page can be done after the tiles have been added, moved or deleted from the workspace. In addition, the method allows the user to edit at any time any of the steps.

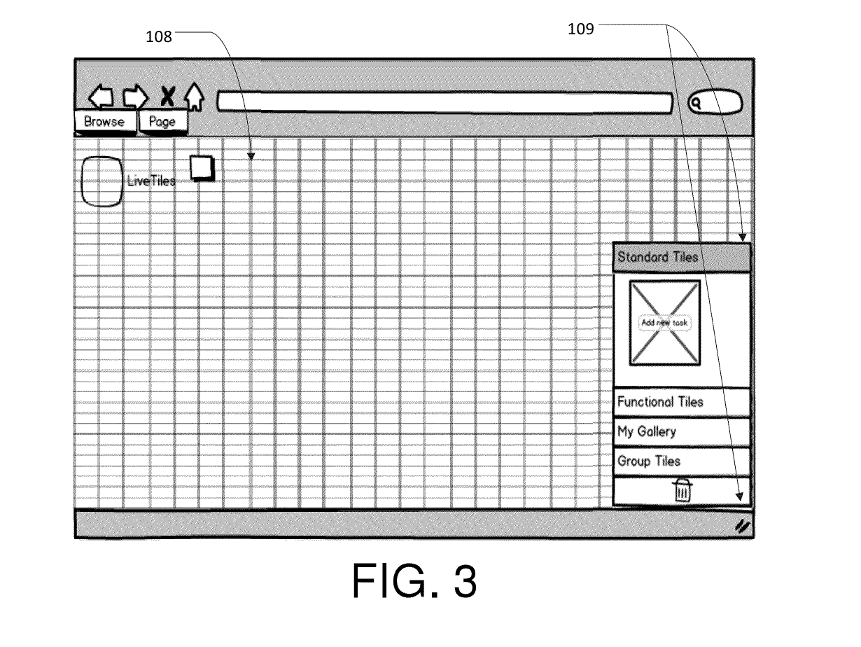

FIG. 3 illustrates one example of a tile workspace. The tiles workspace allows a user to add, delete, move and modify one or more tiles or a group of tiles to create an intranet, internet or extranet page. These functions can be performed by many different techniques known to those of skill in the art. One such technique is by selecting, dragging and dropping a chosen tile or group of tiles using a computer mouse or a touch screen gesture. In addition, the user can select tiles and drag and drop new tiles, functional, or group tiles easily onto a page, delete tiles, and save the page to a gallery.

However, it should be noted that the user can perform any of the multitude of functions such as selecting and moving tiles of groups of tiles in the current template using any type of input device or technique. One type of well-known device is a computer mouse that contains a plurality of buttons that allows a user to hover and select a tile and then drag it to the desired location at which point the user can drop the tile in this location. Another input device contemplated by the inventors is a touch-sensitive screen that would allow the user to select, move and perform functions by touching the desired portion of the display interface.

The method can provide a plurality of templates containing pre-determined tile layouts or configurations. The templates can be selected or changed at any time. For example, the user could have elected a particular template at the page creation step or if the user elected to create a new page then at the tile workspace step. The user can select among these templates for the template having the characteristics desired by the user. In an embodiment of the method if no template is selected by the user, the user will see a blank Workspace with gridlines such as the exemplary workspace 108 shown in FIG. 3.

In addition to the blank workspace, the method can provide one or more boxes, folders, components, menus, tabs, taskbars, softkey bars or links that would allow the user to perform a host of different possible functions. In the illustrative example of FIG. 3, a Tile Menu box 109 on the right hand side of the Workspace is present from which the user can select one or more tiles. Alternatively, the user can be presented with a blank workspace and through user action or by prompts select a template or add gridlines. It should be noted that the order for creation and placement of the tile into the workspace is not important. For instance the features of the tile as set forth in FIG. 2 can be done first and then the tile placed in the workspace. Alternatively, the tile placement can be done prior to the content and features of the tile being inputted. Likewise, the tile configuration can be done prior to adding a title, theme or other attribute such as those set forth in the illustrative example of FIG. 1. This is true of all of the steps of the method. Steps can be carried out in any order that results in the tiled-based intranet, internet or extranet webpage.

The workspace page may also contain one or more task bars containing various components. For example, the task bars may contain icons to assist in navigating between page views or within the workspace itself.

The tiles described herein are managed in a tile Workspace. The tile space can include any number of tiles. The tile space can be a fixed, predetermined size. Alternatively, users can specify the size of the tile space. In yet another alternative, the size of the tile space can vary depending upon the number and location of tiles positioned within the tile space or be based upon the interface of the computing device. The tile space can dynamically grow and shrink as tiles are added and deleted. Although the tile space has been illustrated herein as a grid of rectangular tiles, neither the tile space nor the tiles are limited to a rectangular form. In addition, while the method can provide a set of tiles of set size and shape the method is not limited to such sizes and shapes. Tiles can vary in size and shape. In addition, in the illustrative examples set forth herein the tiles have been depicted at evenly spaced intervals. However, the tile space can allow random or uneven distribution of tiles. Any arrangement of tiles that is useful to users can be utilized.

As stated above, the technique can have one or more modes or views that allow the user to view the tiled based page or to perform one of more functions or tasks. One such mode or view may be an administrative mode or view that allows the user to create, edit or perform other functions and tasks. Alternatively, one or more of these functions may be separated into a different view or mode or accessed in the current mode automatically or by user action. In addition, different subsets of these functions may be grouped together in a separate view or mode or accessed from one of the modes automatically or through user action. For example, the technique may contain an edit mode that when navigated to will allow the user to perform various functions and tasks such as editing of the tiles. Alternatively, one or more functions or techniques such as edit function may be invoked from a view such as the administrative view causing a module box to appear containing possible editing options.

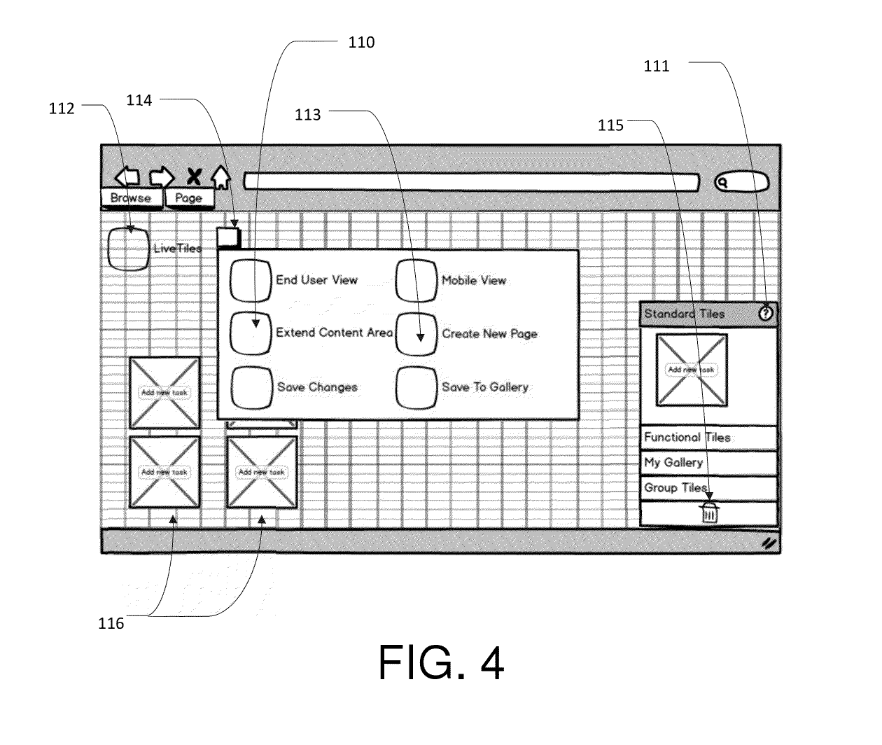

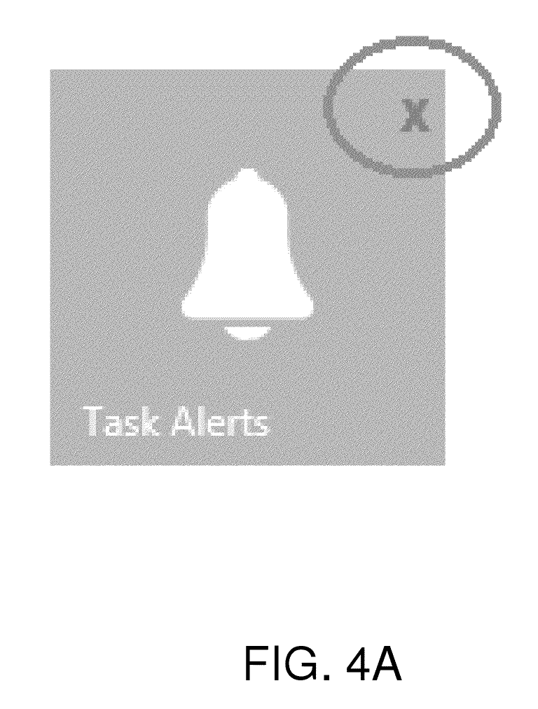

FIG. 4 illustrates the tiles workspace in administrative view. In this example, this view contains an administrative icon 114, that when clicked, will take the user back to a different mode or view. For example, clicking on this icon might place the workspace in normal page mode or edit mode. Conversely, in normal page mode, clicking on this icon may toggle back to administrative view or take the user to another view or mode. The method can contain other types of techniques that allow a user to navigate between views. The user with the correct rights such as an administrator may also have the ability to move this icon as well as the logo 112.

In administrative view the user may create or perform other tasks on the workspace of the tile based page. For example, the user may be able to add tiles to the workspace. There are numerous ways in which tiles can be added, modified or changed that are contemplated to be within the invention. In one embodiment of the technique illustrated in FIG. 4 there can be a box or area on the screen where tiles of pre-set size, shape, quality or function may reside. Alternatively, the user can create or edit tiles using pull-down menus, keystrokes, softkeys, icons and other known ways that would allow tiles to be created or edited into the workspace.

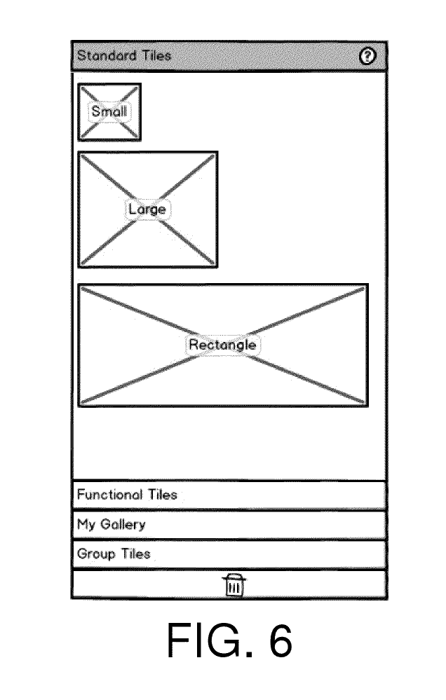

In the embodiment illustrated in FIG. 4, a Tile Menu box is shown superimposed on the workspace with the “Standard Tiles” folder selected. In an embodiment of this method when the user selects a folder contained in a box or list, the selection expands to provide more information related to that selection. In the illustrative example of FIG. 4, when the “Standard Tiles” folder or link was selected this selection expanded to reveal the set of Standard Tiles available for the user to select such as the standard tile options illustrated in FIG. 6. The method can provide that any folder, tab or component when selected expand to reveal the contents of that folder or tab or reveal more information or data. However, other techniques for accessing functions or folders in contemplated as within the invention.

In the illustrative example of FIG. 4, the Tile Menu may also contain a folder, component or tab containing “Functional Tiles” which allow the user to select one or more functional tiles to place into the workspace. Additional folder, component or tabs may be provided from which tiles may be selected. For example, a folder, component or tab may contain the universe of tiles and templates that have been created in the past by the user or an organization. Another folder, component or tab may contain a list of tiles and templates that the company or administrators have created. Further, a list of Group tiles showing the universe previously created tile groups can be provided as well as any list of available or previously created tiles.

In the illustrative example of FIG. 3, the My Gallery folder, component or tab which in this example is contained in the Tile Menu contains a list of tiles that a company, organization or administrator has created. When a user selects the “My Gallery” tab on the Tile Menu, it will display a list of tiles that the company or administrators have created. A search method to search for tiles, templates or groups of tiles within the My Gallery tab or other tabs, menus or folders can be provided.

The Tile Menu box or similar area can contain other folders or menus containing tiles or group of tiles that can be added to the workspace to allow customization according to the preference of the user.

In the embodiment illustrated in FIG. 4, the user will be able to drag and drop as many tiles from the Tile Menu that can fit on the screen or that the user wishes to place on the tiled based page. Using an input device such as a computer mouse the user selects the type of tile to be placed onto the Workspace. Using the mouse the user then drags the tile to the position where the user wants the tile to reside and drops the tile at that location. On the drop of the tile, the method provides a technique that will properly place the tile to fit within one of the gridlines so that tiles can be easily aligned without the need to move each tile pixel by pixel. In FIG. 4 tiles 116 have been dropped and properly placed within the Workspace.

Other techniques for selecting tiles to be placed in the workspace and to indicate the position at which the user desires such selected tile to be placed are within the method of the invention.

The method can provide techniques for automatically placing, sizing or reflowing the array of tiles into which, or from which, a tile is placed or moved. As part of reflowing tiles within an array, various rules may be used, such as top-to-bottom and then left-to-right. Other rules may instead be used, such as right-to-left or bottom-to-top (e.g., in cultures where language is not commonly arranged left-to-right).

The method can provide techniques for fitting the tiles onto the workspace. This can occur for example, if the user attempts to fit a tile of a set size onto a portion of the workspace that does not contain enough space for the selected tile. In one embodiment the method will visually or verbally inform the user that the selected tile cannot fit in the desired space. The method can provide techniques for re-sizing the selected tile or one or more of the tiles currently in the workspace to allow the selected tile to fit within the desired area on the workspace. The method can also provide techniques for resizing the workspace.

Further, prior to placing the tile at the selected location, the technique can indicate the location at which the selected tile will be placed, such as through tilting an immediately superior tile or a current tile in the location responsive to a dwell, hover, or movement over the location of the selected tile. The technique may also indicate the location by previewing the arrangement of the array should the tile be placed at the location and the array of tiles be reflowed based on the placement.

The method can also provide techniques that allow a user to extend the tile workspace. These techniques may be provided in the administrative mode, in a separate view or accessed in any of the views by user action. Likewise, these techniques may be accessed in any numerous ways known to the person of skill in the art.

In the illustrative example of FIG. 4 extending the tile space is performed by clicking the admin icon 114. This will take the user from the current administrative mode to edit mode. This can cause a box to pop up containing various functions and features. In the illustrative example, the user would select the “Extend Content Area” 110 feature. The edit mode may also contain other techniques to provide a host of other functions and tasks.

When an extension is selected that will result in the workspace being larger than the display interface, the method can provide techniques to allow the user to navigate such as by providing a scroll bar. In an edit mode this will allow the user to add tiles to the workspace in areas previously not displayed. When the page is in normal view mode or end user view the technique can provide a scroll bar to allow the end user to scroll through the whole workspace.

The method can also provide the users the ability to delete tiles. There are numerous techniques known to those skilled in the art that can achieve this function. For instance the tiles themselves can contain a functional or softkey bar that contains functional components such as a delete function. This bar could be always visible, may appear only when the tile is selected or appear when a selecting device hovers over the tile. Alternatively, functions including a delete function for a tile may be accessed by specially clicking on the tile or may be accessed in the taskbars of the workspace page. Other techniques can be employed in the method to perform functions, including deletion of tiles or groups of tiles.

In the illustrative example of FIG. 4A, the tile itself contains an “X” at the top of the tile. Clicking on the “X” will delete this particular tile. Preferably, when the “X” is selected, it will prompt the user with “Are you sure you want to delete this tile? Continue/Cancel.”

As stated above the method can also provide other techniques that perform other functions. These can include create new page, save changes, save to a list or gallery, go to another view, save and publish page, publish page, end the current view and a host of other possible functions. As stated above, these functions can be accessed in numerous ways or through any of the modes or views. In the illustrative example of FIG. 4, these functions are accessed in the edit mode, whereupon a pop up box containing a list of the functions appears. The user then can click on the desired function. Other ways to access functions are within the method.

In the illustrative example of FIG. 4, the method has provided a “Create New Page” 113 in edit mode that was navigated to by clicking on the admin icon 114. Selecting this function will result in a new page being created. Other functions can be included either in a module box, on a task or softkey bar or by any other method.

A help button 111 may also be added to assist the user. In the illustrative example, the help icon is contained on the Tile Menu. In one embodiment if the Help button is selected a help dialog will appear as a module window in the workspace. In other embodiments the help function may be accessed from different locations and ways.

The method can also provide a user with the ability to open previous draft pages, save pages, publish the new page and save the whole page as a template within a page gallery. Numerous techniques can be used to carry out these functions within the method.

In the illustrative example of FIG. 4, the user can “Save Changes” for a page by clicking on the admin icon to navigate to the edit mode. A user will be able to save the page to a list or folder so it can be used as a template when someone wants to create a new page. In an embodiment of the method, the user can save using a text label or any identifying label. In one an embodiment the user can create or save the template as an icon representing the page for easy recognition when selecting a template. Preferably, the icon will relate to the template page in some way to allow easy recognition of the template page when viewed by a user. In the illustrative example, the user can click on the “Save to Gallery” button to save the template to the My Gallery folder or list. In one embodiment when the same template exists with the same name, the method will create a new version of the template. In an embodiment of the method when a user selects “Save page to the gallery,” it will open a sliding form that will request the Name and Icon or other identifying indicia for that template.

As stated above, the method can provide other functions whether in a module box as in the example of FIG. 4 or accessed by other known ways. One such functions can be “Save and Publish Page.” Publishing a page will allow the user to publish this page as a live site and override the existing site. It will default to the same location as was chosen when the User created the page. Preferably, when “Publish Page” function (not shown) is selected, it will bring up a prompt, “Changes will be updated and will override the current page” “Continue/Cancel.” Another function that can be provided in the method is a technique to open an existing saved page. The user selects this function and preferably a list of saved pages appear for example, in a list, folder or module box. The user then chooses the page to open and the method implements the user's choice. In one embodiment of the method when the user selects the open page function a module box appears that displays a list of saved pages by name, icon, version or any identifying way.

The method can provide techniques that will allow a user to search for previously created pages and to open such pages. Once a page is opened the user can modify the page or publish it. There are numerous techniques for searching, accessing and displaying a list of pages as well as for selecting a page that are known by a person of skill in the art.

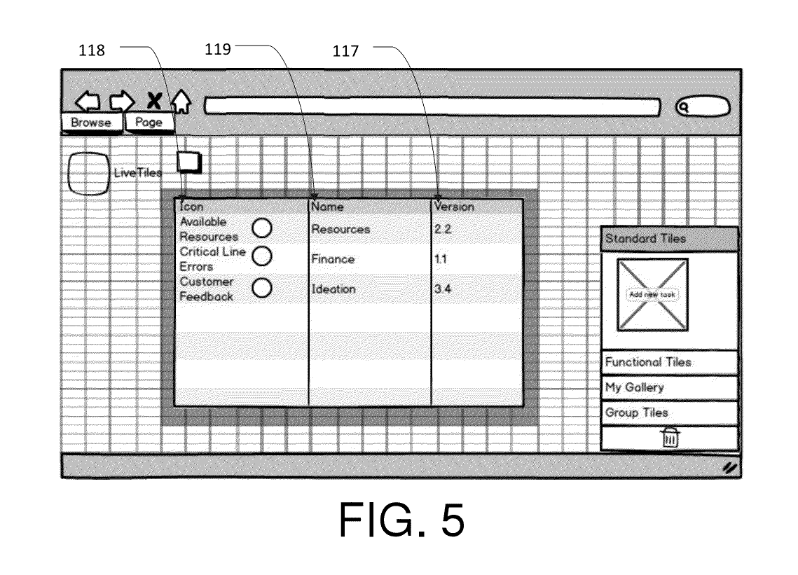

FIG. 5 illustrates the workspace when the user has selected the “Open Page” option. In this example, a module box appeared on top of the workspace with a list of saved pages. In this example, each saved page is listed by the icon 118, name 119, and version number 117. Other ways to show saved pages is certainly contemplated as within the method. When a saved page is selected, it will open that page. In the illustrative example, the page is opened in the edit/Tiles Workspace mode. The user can perform the necessary functions to this page including edit, and publish the page. In this illustrated example, the user can select the desired page to open by selecting the radio button associated with the desired page.

FIG. 6 illustrates a blow up view of the Tile Menu of the illustrative example of FIG. 4. As previously stated, the use of a module box or area containing tiles ready to be selected of dragged into the workspace is just one embodiment of the method to make a tiled based page. Other techniques are contemplated that are within the invention set forth herein. In the embodiment of FIG. 4, the Tile Menu contains several selectable folders, tabs or components, including Standard Tiles and Functional Tiles. In FIG. 6 the Standard Tile folders or components has been selected causing it to expand to show, in this example, three standard tiles that a user in this example can quickly drag onto the workspace: small, large, and rectangle. Other embodiments may have different numbers or kinds of standard tiles or may not contain any standard tiles.

Alternatively, the numbers or kinds of standard tiles may be linked to a particular theme or other attribute of the intended tiled based page. For example, the method can provide a technique for the user to assign a page with a theme, title or other attribute to the page at creation or at a later time. In the illustrative example of FIG. 2, the user was prompted to pick a color theme. The method can further provide a technique for changing the theme, title or other attribute to the page. Each theme can contain numerous attributes or characteristics such as color schemes.

Further, tile attributes or characteristics can be assigned to a theme, title or other attribute to the page so that these attributes or characteristics will be automatically presented when the theme, title or other attribute to the page is selected. Attributes or characteristics may include color, shape, size or tile functionality.

In an embodiment of the method when the user selects the theme upon setting up the page or if the theme is changed the standard tiles will reflect that theme, title or other attribute to the page. For example, in one particular embodiment if the user selects a certain theme upon setting up the page or if the theme is changed the standard tiles will reflect the same colors from the theme. In a further embodiment if the theme contained three core colors there the method can provide three standard tiles each reflecting one of the three core colors. In another embodiment if the theme contained three core colors there the method can provide three standard tiles each reflecting one of the three core colors but they will be different colors.

The workspace can support a variety of tile types, including standard tiles and functional tiles. Standard tiles have no link to content or other applications either local or remote. Standard tiles can be used to add text, images, graphics or just be blank.

The functional tiles can include a list of functions that a user can add onto the workspace. Some functional tiles can be more configurable than others but will have specific functionality and can be of all different sizes. Functional tiles can be arranged in numerous different ways.

Functional tiles can display or represent content provided or maintained by a software application local to the computing device or remote to the device. For example, the computing device can include a contact software application that maintains a list of contacts with associated contact cards. Contacts are generally individuals or entities and contact cards generally include information associated with a contact (e.g., name, title, telephone number, email address, physical address and the like). A functional tile can act as a shortcut to a contact card included in the contact list maintained by the contact software application on the mobile device. If the functional tile is a background tile, the thumbnail view can include an image of the contact, text or any other information regarding the contact. The functional tile can include a context indicator for the contact. The context indicator can show the current state of the contact such as whether the contact is online, the contact's location or any other property of the contact. In summary or background view the functional tile for the contact can include graphics, text and any other information associated with the contact.

A functional tile can also provide the user with the ability to launch the software application associated with the functional. Users can view limited functional information from a background tile. Users can view additional functional information using the summary view. However, the user may wish to perform additional functions, such as updating the contact card. The functional tile can provide a user with the ability to launch the full contact application directly from the tile space, without requiring the user to navigate to a menu of available applications.

Functional tiles can host controls with which the user can interact to preclude requiring the user to navigate away from the tile space to an application. For example, an independent tile can provide a calculator function. A keypad for a mobile device can provide users with the ability to enter numbers. The calculator tile can utilize basic controls such as on screen buttons to implement operators (e.g., +, −, / or *). In another example, an functional tile can provide a simple messaging function or an alarm or clock function.

Functional tiles can also have links in them or contain audio or video embedded in them. Functional can be retrieved or obtained from a remote source, such as a server. Vendors of services or data can generate and offer tiles to users. Functional tiles can obtain a variety of functional from remote sources. For instance, a user may subscribe to a news service. A tile can display a subset of news provided by the news service and/or as well as an indication of important news bulletins. In a further example, a tile can provide user with access to one or more maps frequently utilized by the user. Typically, geographic data sets such as maps are large.

Vendors can provide tiles to users as a service. Users can be required to subscribe to the service to obtain functional. Alternatively, vendors can provide tiles to users to perform targeted advertising.

Functional tiles can also provide the ability to directly access an associated remote service without having to navigate to a menu of applications.

A functional tile can also provide a user with quick, direct access to an application. Activation of the tile launches the associated application without requiring a user to navigate to a list of applications to search and select the desired application. For instance, an functional tile can provide a link to a game or other application. Thumbnail and summary views for functional tiles can include graphics, text or other suitable visual cues to allow a user to easily identify the application.

The tile space can also include shortcut tiles. Shortcut tiles can provide shortcuts or links to any other location on the mobile device. For example, the mobile device can include another user interface for navigating mobile device functional. Users can utilize a shortcut tile to leave the tile space and navigate to the alternate user interface.

Functional tiles can also link to forms or other documents, images or other content saved either locally or remote. A functional tile may also contain navigation functions to assist the user to navigate around the tile based intranet, internet or extranet websites.

Tiles can include any combination of text, graphic images, hyperlinks or any other visual representation in both summary view and thumbnail view. Further, an image can be used as the background of the tile with text overlaying the image. Each individual tile can include multiple cells or columns that can be populated with data of varying data types. For instance, a messaging tile can include a column or cell for an icon that can reflect the method of communication (e.g., voicemail or text message), a cell for text including the message functional and a cell for text including the sender name. Different columns or cells can have separate tasks associated with the individual columns. Accordingly, selection of an icon within a tile can generate different task options than selection of the sender text in the same tile. In addition, tiles can include audio cues or data. For example, audio data may be triggered when a tile is active or selected.

The method can provide other types of tiles that a user wants in on a tile based intranet, internet or extranet websites.

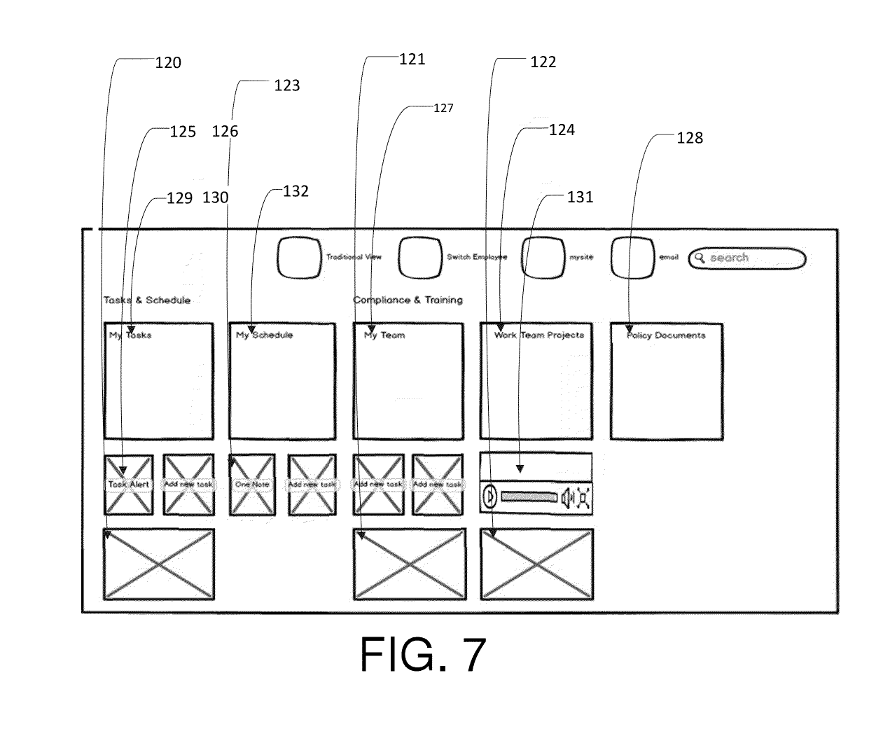

FIG. 7 illustrates examples of functional tiles in a workspace. In this example, the functional tiles include: My Tasks 132, Task Alert 124, My Schedule 131, My Team 127, KPI tile 126, Document live tile 128, Video tile 130, Image tile 122, Newsboard 121, Newsfeed 120, Live tile 129, Active tile 125, and Static tile 123.

Functional tiles can be added using the same technique as with adding standard tiles or by any techniques. Examples include a list, menu or tab containing functional tiles is selected. In the illustrative example of FIG. 5, the tab is contained on the Tile Menu module box. Once selected a list of possible functions can appear. The list can be delineated by name, icon or any identifying method. A particular functional tile can be selected and a position for the functional tile can be selected in the workspace. In one embodiment of the method an input device can be used to select, drag and drop the functional tile into the workspace. In another embodiment of the method the functional tiles which can represented by only a name or icon which can be dragged into the workspace. Upon dropping at the desired position in the workspace the functional tile or icon of this tile expands to its active size.

The method can provide techniques to allow a user to group or link two or more tiles together and saved as a group. Groups can be based upon certain characteristics or metadata. For example, some tiles might contain similar attributes or relationship and a user would want these tiles to be grouped together. Further, the method can provide techniques that will keep grouped tiles together when moved by the user. The method can provide other techniques for linking two or more tiles whether the tiles are adjacent to each other or not.

The method can provide techniques to list and retrieve grouped tiles. In one illustrative embodiment of the invention depicted in FIGS. 4, 6 and 8, the listing of the Group Tiles is contained on the Tile Menu. However, the technique for assessing Group Files if included in the tiled based page can be through any known technique.

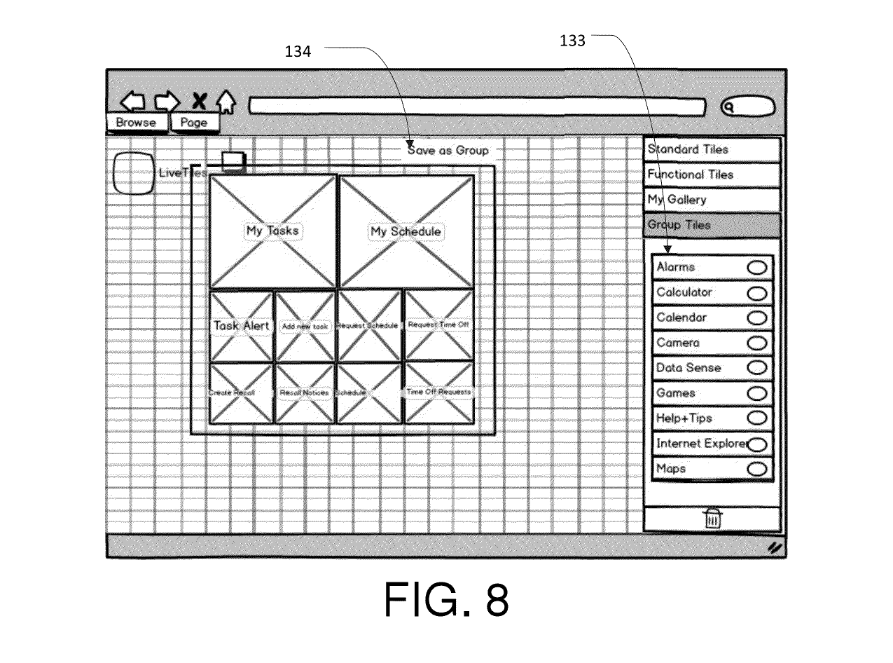

FIG. 8 illustrates the concept of Group tiles in an illustrative embodiment of the invention. In this embodiment Group tiles can allow a user to group a set of tiles together, save all of the properties including the spacing and color so that they can be easily dragged onto the workspace. In this example, a group of adjacent tiles have been selected to form a group. Selection can be in any known way, including making a box around the desired tiles using an input device or by highlighting adjacent tiles by clicking on them. Either automatically or by user action, an option, icon or pop up box may appear containing the function of saving the desired group of tiles as a tile group.

In the example in FIG. 8 the user can create a group of tiles using a mouse or other input device such as a touch screen gesture by hovering over a set of tiles. When selected, the techniques can provide an option to appear such as Save as Group 134. In an embodiment of the method selecting this option may result in a module box appearing with the ability to enter the identifying indicia for this group such as group name or group icon. An option in the module box can allow the user to save the group with the identifying indicia entered by the user.

Moreover, the method can provide a technique to allow the user to move and drop the tiles as a group. In the illustrative example in FIG. 8 the Group tile folder, component or tab is on the Tile Menu and when selected expands to reveal a list of tile groups 133 that can be selected by the user. The method can also provide a search feature that will allow a user to search for a tile or a group of tiles by name or label. The search feature can be contained on any part of the workspace, including one of more of the task bars, the Tile Menu or in the Group Tiles folder, component or tab.

The method can provide for techniques to allow a user to label a tile or a group of tiles with text, icons, or other identifying markers. Labels can be associated with a tile or a group of tiles in numerous ways. For example, a label such as text can be inserted within the tile by using an input device such as by typing text or dragging text. Alternatively, each tile or group of tiles may contain a label box within the tile or group of tiles or accomp[anying the tile or group of tiles. Alternatively, the label may be on the workspace either near the tile or group of tiles or somehow associated with the tile or group of tiles.

The method can provide techniques to assist a user in selecting and placing selected tiles or groups of tiles in the tile workspace from a reservoir of tiles or from the workspace. For example, once selected tiles or groups of tiles can expand or contract or all or part of the tile or group of tile can change color indicating the tiles selected. When the user selects the desired placement of these tiles in the workspace and the user indicates so by, for example, dropping the tile or group of tiles whereupon the tiles or group of tiles revert back to the default characteristics. In one embodiment of the invention when a tile such as a functional tile is selected and dragged from where it resides such as in the tab on the Tile Menu the tile or group of tiles shrinks to prevent the tile from obscuring the workspace. This allows the user to better position the tile at the desired location in the workspace. Upon employing the drop function, the tile or group of tiles expands back to the desired size. Alternatively, the tile itself may be represented only by an icon, name or other identifier in the tile list or tab and not the actual active tile. This representation of the tile then can be selected and placed in the workspace whereupon it becomes the actual working tile.

The method can also provide techniques that will allow a user to set various parameters for a tile or a group of tiles. Such parameters may include title, icon, height, width and color although many other parameters can be included.

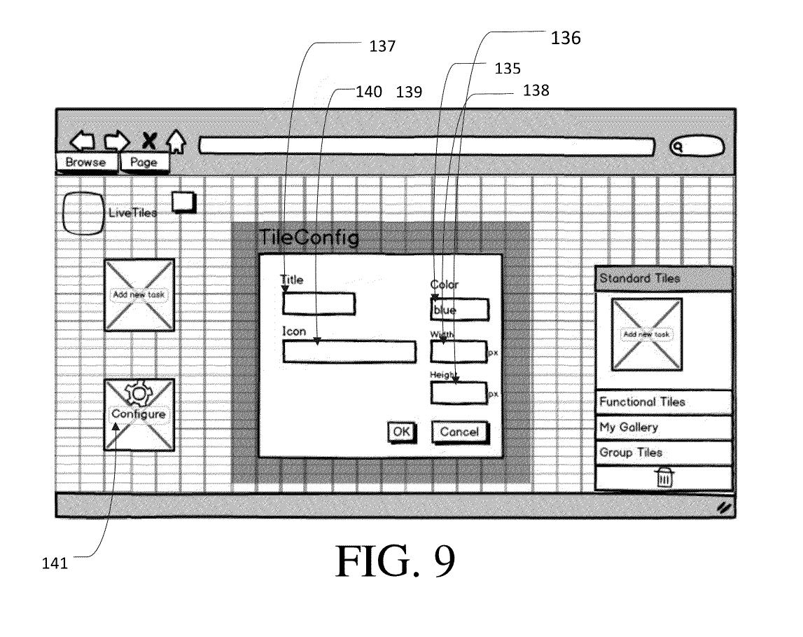

FIG. 9 illustrates Tile Configuration which is a possible function that is within the method. When a tile or a group of tiles is placed or moved on the workspace or after being moved the method can employ either automatically or through user action a technique to configure the tile or a group of tiles that was just placed on the workspace. Configuration allows the user to change one or more characteristics of the tile or group of tiles. Numerous possible characteristics may be configured, including title, icon/image, tile color, tile width, tile height, title position, title size, URL or Page, “Open in Model Window” checkbox, “Mouseover Highlight,” “Color Bar,” Color Bar Active, List item count, “Active” checkbox, or “Connect to a List” checkbox.

In the illustrative example of FIG. 9, when the tile in the lower left corner was selected and placed by dragging onto the workspace from the Tile Menu a Configure icon 141 automatically appeared. Selecting this icon by, for example, clicking on it will cause a module box to pop up labeled, in this example, “Tile Config” to appear containing one or more configuration settings. Possible configuration settings include title 137, icon/image 138, tile color 135, tile width 139, and tile height 136. The user then inputs the desired configuration parameters for each setting through any input means. When the user is finished entering the configuration parameters the method allow the user to save and implement the function. In the example of FIG. 9, the user saves the settings by clicking on the OK function.

Other techniques can be employed for a user to configure a tile or group of tiles. For example, the configuration function can be accessed through a taskbar or softkey bar contained on the workspace or on the tile itself. These softkey bars may be visible at all times or appear only through user action. In addition, the configuration function can be in a separate mode or view of accessible in any view or mode.

The method can be employed on any computing device containing a web browser application, including a desktop computer, a laptop computer, a tablet computer, a smart phone, a set-top box, a smart television or a gaming device. The method can include techniques to allow a user to create or modify a page in a browser in any computing device. Depending on the type of computing device the method can provide different building techniques to create browser pages and apps corresponding to the computing device. In addition, the method provides techniques to build a page for one computing device using another type of computing device.

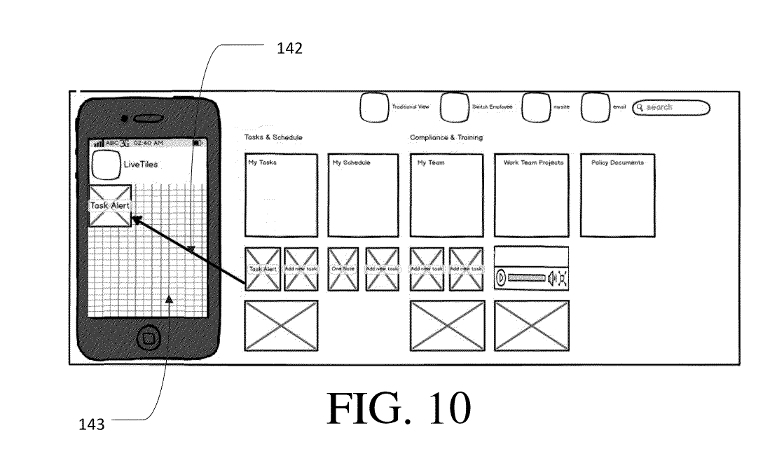

FIG. 10 illustrates an example of creating a page for one computing device using another computing device. In this example, the function is called MobileBuild and lets the user build a page for a mobile device using a different device. This functionality can be accessed in any way such as in creation mode, edit mode or its own mode. The MobileBuild functionality allows a user to easily create a mobile app in seconds. It allows the user to build this from for example, a desktop computer. When a user decides to create a new page the method can either through prompts or user action select the intended computing device for the mobile build. This can be done, for example, by device name, make or model for the new workspace. This will conform the workspace to the selected computing device. A grid conforming to the selected computing device appears in a create mode. The user then can select and place tiles onto the workspace grid from the tile inventories. The user can also edit the workspace by selecting edit or by entering the edit mode. When the user has finished creating or editing the workspace the user can save the created template. The method can provide techniques to allow the user to publish the site just created.

In addition, the method can provide techniques that will provide access to the template to other users for example by creating an URL that when accessed will display the templates. Templates can be displayed by the make and model of the computing device.

In the example illustrated in FIG. 10 the user has selected the MobileBuild functionality and has selected the type of device. In this example, the user has selected a mobile telephone. A representation of the workspace of the selected device (in this example a certain make of mobile telephone) is shown 143. For example, if an Apple iPhone® is selected, it will show and rescale the gridlines to that phone size 143. The method can provide a function that will allow the user to change the intended device such as changing the type of mobile telephone. When selected the mock-up workspace will change to conform to the workspace of the new selected device. To edit the workspace for the intended device the user can select and place tiles from the tile inventories or from the workspace of the computing device being used.

In the example of FIG. 10, tiles from the workspace of the desktop computer are dragged and dropped into the workspace of the mobile telephone of choice 142. The created template can be saved for access by others.

The method can provide techniques that will allow the user to save the template created for a particular computing device for all or selected computing devices. For example, if a user has created a template for one make of mobile telephone the method can provide a technique to create templates with the same content for all mobile telephones with workspaces conforming to each mobile telephone type.

The method can also provide techniques that allows the templates to be published so that when people access that URL it will display all the different computing device templates in slightly different formats. The method can also provide a technique that will update these templates.

The method can also provide tiles for many types of smartphone, including iPhone®, Android®, and Windows Phone 8® app. These can be any type of tiles. One such tile can include a tile that allows a user to save and retrieve user names and passwords in one location.

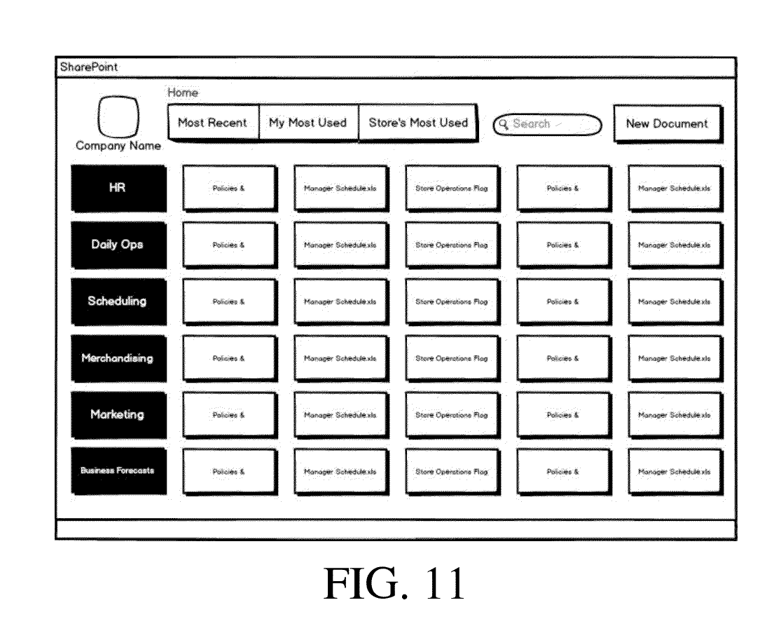

The method can also provide a technique to allow tiles to be accessed on an internet, extranet, or internet site by touching the tile on the display device. Selecting a tile in this manner can for example, invoke the tile's functionality or other functionalities, open or expand a folder, present a list of files or allow other functionalities. FIG. 11 illustrates an embodiment of this Touchlist feature.

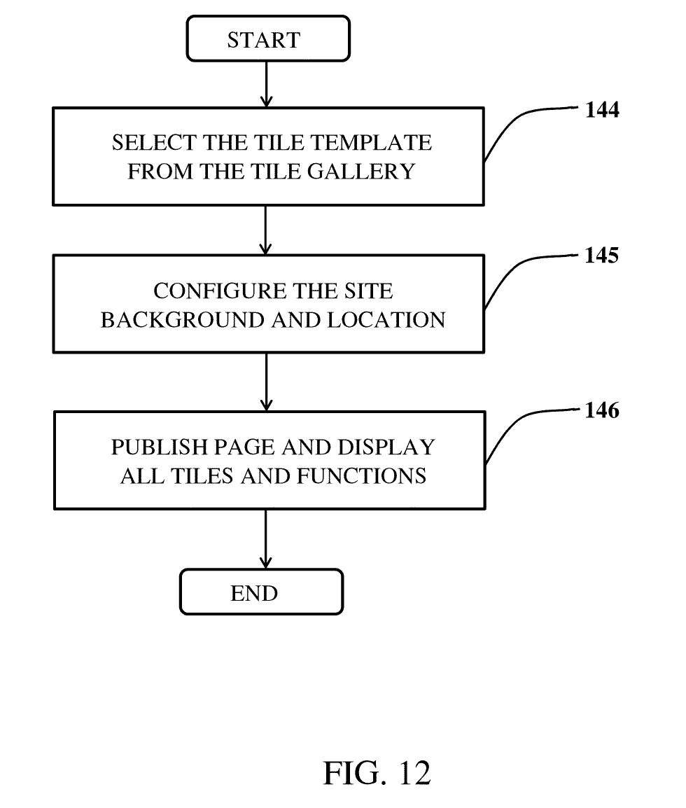

In view of the exemplary systems described above methodologies that may be implemented in accordance with the disclosed subject matter will be better appreciated with reference to the flowcharts of FIGS. 12-15. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, carrier, or media.

Referring to FIG. 12 this provides a methodology for creating a new page from a gallery or pre-configured template of grouped tiles. At 144 it describes selecting a template from the Tile Gallery of pre-configured page templates. The page can then be further configured by selecting the name, page location and background color or image of the page 145. The user can then publish the page to that location and the site will be created based on the pre-configured tile formation and the configuration settings that have been selected 146. There can be an unlimited number of page templates created by the system or the user and this process can be selected at any-time during a page build or if a user builds a page without using a template by starting with the Workspace.

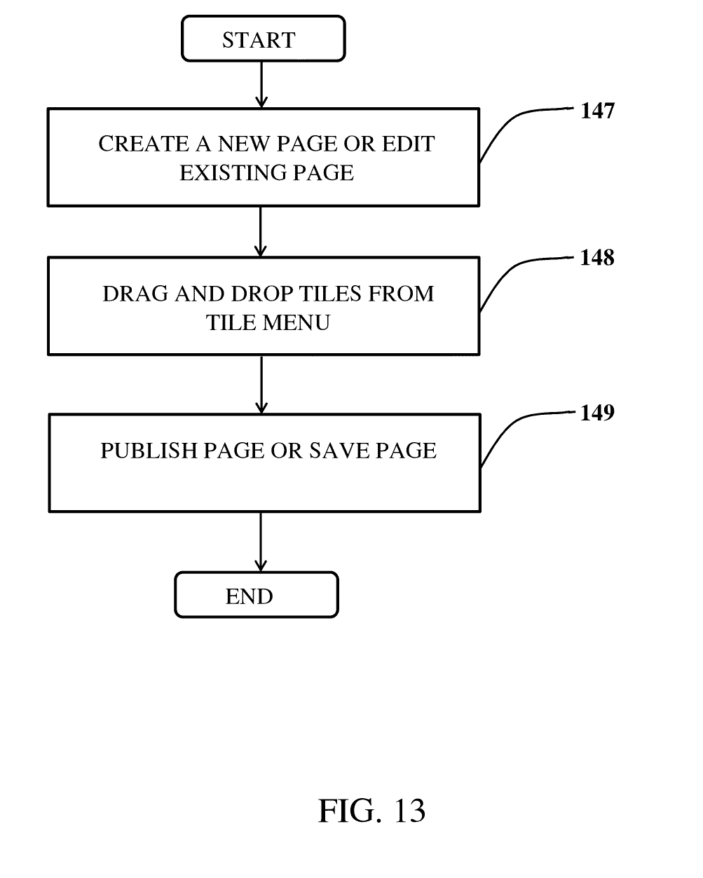

FIG. 13 illustrates a methodology for editing and adding tiles utilizing the Tile Menu in the Workspace. A user can add tiles via the Workspace at any stage from either creating a new page from a template or editing a page that currently exits FIG. 13. At step 147 the process for accessing the Tile Menu so the page can edited requires that the Administrator is in the Workspace. The user is then able to drag tiles from the Tile Menu and drop them on the Workspace in any layout including the header and footer of the page 148. The tiles can then be moved anywhere on the page and if the Workspace is extended, the tiles can further extend horizontally on the Workspace. When all of the relevant tiles have been placed in the desired location, the user can save the page to work on the page at a later stage or the page can be published to all of the end users for immediate access 149.

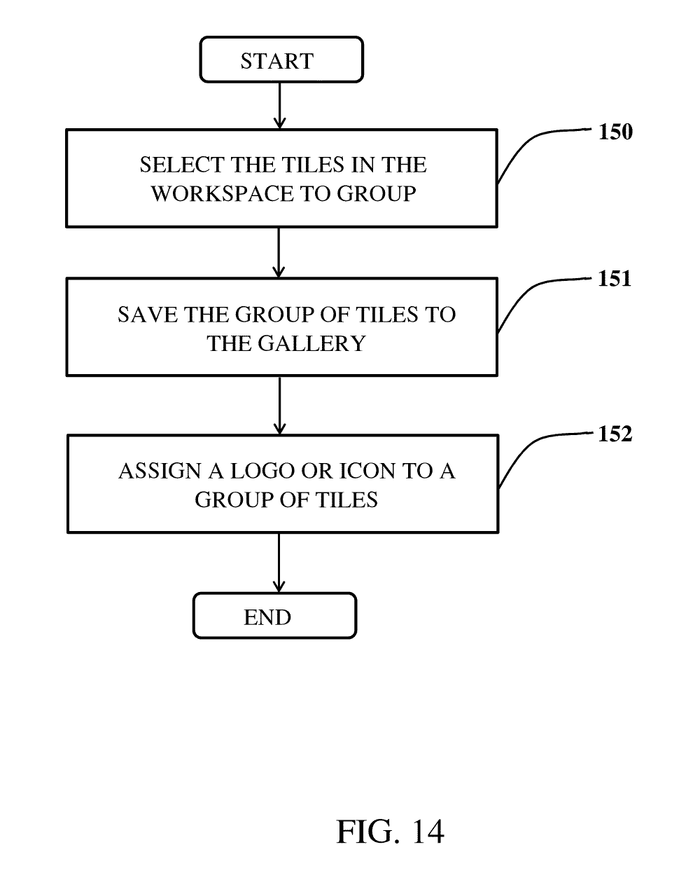

FIG. 14 illustrates a methodology for creating a set of grouped tiles and saving this as a group in a group gallery. A user is able to group a selected number of tiles in the Workspace and save this group to the gallery so that these tiles can easily be added to new pages FIG. 14. The user is required to select the tiles that need to be grouped by either checking each tile or by drawing a box around the tiles that they wish to group in the Workspace 150. When the user has selected the tiles they wish to group they are able to save the group to their gallery so they can be accessed for future pages that are created 151. When the user is saving a group of tiles to the gallery they are able to select a logo, such as a company or software logo that relates to the group of tiles, or an icon to describe the group of tiles 152. This icon or logo will then be available in the group tiles gallery and the logo or icon will easily identify the group.

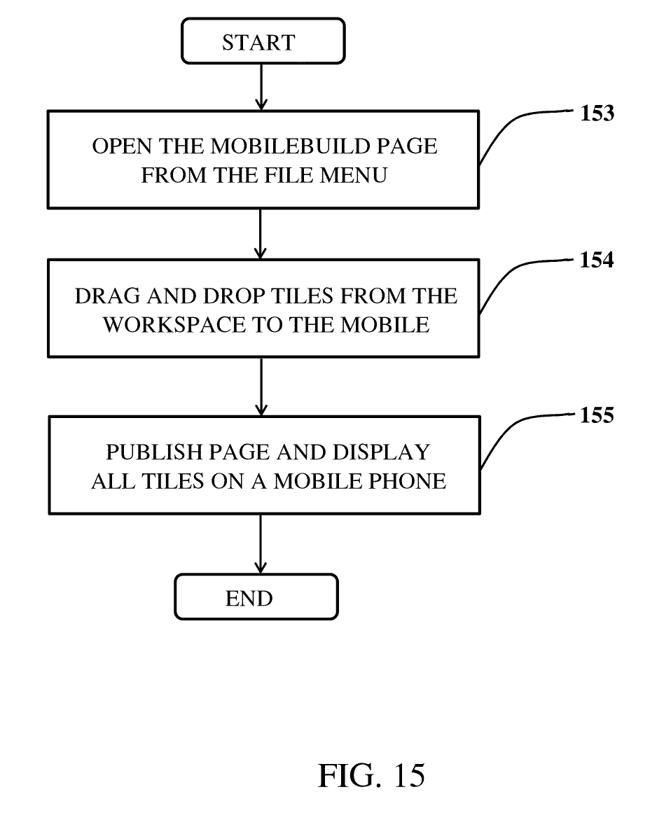

FIG. 15 illustrates a methodology for creating a mobile site via the Workspace using the MobileBuild function. The MobileBuild will allow a user to create a mobile phone site optimized for a mobile screen very simply from the Workspace. To create a Mobile Phone site the user opens the MobileBuild page from the File Menu 153. The user can use the current layout create for a desktop or tablet view to create a Mobile Phone view by dragging the icons created for the desktop or tablet view onto a picture of a Mobile Phone on the desktop 154. Tiles are dragging from right to left onto the picture of the Mobile Phone and they are placed in the order and in the position required by the user. The user can then publish the page to a Mobile Phone 155. When the user accesses the site on a Mobile Phone they will then see the tiles as arranged by the user in the desktop web browser view. This will publish the MobileBuild page to all major Mobile Phone brands using device channels.

### CONCLUSION

This program will aid users in creating sleek, seamless interface designs that will invariably lead to internet, extranet, or internet sites having the highest adoption rates. It provides a user-friendly experience in:
1. Creating pages and choosing templates.
2. Utilizing the tiles Workspace to drag and drop tiles.
3. Opening, saving, and saving to the gallery.
4. Choosing from a large array of customizable tiles, both standard and functional.
5. Grouping tiles together, thereby increasing efficiency and customization.
6. Configuring tiles for optimum customization.
7. Integrating these features with mobile devices for cross-platform accessibility and operability.

### FIGURE REFERENCES

0. Front Page
1. Example System
100. Web Effect Class Libraries
101. Data Model
102. Web Effects Control Layer
103. Functional Flow Logic
104. UI
2. Create Page and Choose Template
105. Page Name
106. Pre-populated with current name of tile
107. Theme—Color
108. Background
109. Application Link
110. List of application types
111. Preview in application gallery
3. Tiles Workspace
112. Administration Mode
113. Extension of Content Area
114. Creating a New Page
115. Help Button on Menu
116. Alignment of tiles when dropped
4. Tiles Pages—Open, Save, and Save to Gallery
5. Standard Tile sizes
6. Standard and Functional Tiles, My Gallery
7. Group Tiles
117. Saving group tiles
118. Tile list
8. Tile Configuration and Save to Gallery
119. Settings icon and configure text
120. Title
121. Title Position
122. Title Size
123. Icon/Image
124. URL or Page
125. Tile Color
126. Tile Size
127. “Open in Model Window” check box
128. “Mouseover Highlight”
129. “Color Bar”
130. Color Bar Active
131. List item count
132. “Active” check box
133. “Connect to a List” check box

What is claimed is:

1. A system comprising a processor and a computer-readable storage device, the device storing executable instructions that when processed by said processor causes said processor to implement the steps comprising:
creating a new intranet, internet or extranet page; and
adding one or more tiles to the intranet, internet or extranet page.

2. The system of claim 1 wherein the intranet, internet or extranet page includes a tile workspace.

3. The system of claim 1 wherein adding one or more tiles is by user interaction.

4. The system of claim 1, wherein said processor processes said executable instructions to further implement the step of dynamically updating the one or more tiles.

5. The system of claim 1 wherein the intranet, internet or extranet page is on a mobile device.

6. The system of claim 1 wherein said processor processes said executable instructions to further implement the step of publishing the page.

7. A system for arranging tiles in an intranet, internet or extranet page comprising:
a user interface;
a web effects controller component;
one or more web effect class libraries; and
a functional flow logic component.

8. A computer-implemented method comprising:
creating a new intranet, internet or extranet page; and
adding one or more of tiles.

9. A computer-implemented method of claim 8 wherein the adding one or more tiles comprises:
selecting one or more tiles from a tile list of available tiles to add to the intranet, internet or extranet page; and
positioning the one or more tiles on said intranet, internet or extranet page.

10. The method of claim 8 further comprising the step of publishing said intranet, internet or extranet page.

11. A computer implemented method of claim 8 further comprising configuring the selected tile template.

12. A computer implemented method of claim 8 further comprising creating a grouping of tiles on an intranet, internet or extranet page by selecting the tiles on an intranet, internet or extranet page to be grouped together and saving the group of tiles in a list of available tile groups.

13. An user interface for a mobile device facilitating surfacing of content available through a web browser for the mobile device, comprising:
an interface component that obtains the content;
a tile workspace component that manages a plurality of tiles dynamically updated based at least in part on the content and positioned within a tile space; and
a display component that displays a view of the tile space.

14. A system providing an enhanced user interface, comprising:
means for generating a customizable tile workspace capable of managing one or more tiles;
means for populating the customizable tile workspace with said one or more dynamically updating tiles; and
means for displaying a view of the tile space.

15. The system of claim 14, further comprising:
means for receiving user input; and
means for navigating through the tile space based at least in part on the user input

16. The system of claim 14 further comprising:
means for selecting the one or more tiles from a set of available tiles based at least in part on user interaction.

17. A computer-implemented method to edit an existing intranet, internet or extranet page comprising:
selecting tiles to add or remove from said intranet, internet or extranet page;
adding or removing the selected tiles;
publishing the edited intranet, internet or extranet page.

18. A computer-implemented method to create an intranet, internet or extranet page for use on a mobile device comprising:
creating a tile workspace for mobile device;
selecting one or more tiles to include in the tile workspace for the mobile device; and
positioning each of the selected tiles on the tile workspace at a desired location on the tile workspace.

19. The computer implemented method of claim 18 further comprising publishing said created intranet, internet or extranet page.
